(19) United States
(12) Patent Application Publication
(10) Pub. No.: US 2006/0266596 A1
(43) Pub. Date: Nov. 30, 2006

(54) Integral combination of front fork and disk brake assembly

(76) Inventor: Hui-Hsiung Chen, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/139,472

(22) Filed: May 31, 2005

(51) Int. Cl. B62L 5/00

(52) U.S. Cl. 188/26

(57) ABSTRACT

A brake assembly is integrally connected to the front fork and a chamber is defined in the brake assembly and a brake mechanism is received in the chamber. The brake mechanism includes two lining plates and a brake unit. A brake disk is located between the two lining plates which are moved toward each other by the brake unit. The parts of the brake assembly is integrally manufactured so that the accumulated tolerance is reduced and the assembly steps are therefore simplified.

### FIELD OF THE INVENTION

The present invention relates to a disk brake assembly which is integrally connected to the front fork so as to increase the precision of assembly and to reduce the range of accumulated tolerance of the parts of the brake assembly.

### BACKGROUND OF THE INVENTION

A conventional disk brake assembly is shown in FIGS. 9 and 10 and is connected to lugs 73 on the front fork 71 and a disk 72 is connected to a hub of the front or rear wheel. The disk brake assembly 74 includes a first part 741 and a second part 742 and a groove 743 is defined between the two parts 741, 742. The brake disk 72 is inserted in the groove 743. A brake unit 744 is connected to the brake assembly 74 and includes two lining plates which are located on two sides of the brake disk 72. A fixed bar 746 integrally connected to the first part 741 and a swing arm 747 is pivotably connected to the first part 741 and connected to the brake unit 744. A brake cable 748 is fixed to the swing arm 747 via the fixed arm 746 so that when the user pulls the brake cable 748, the swing arm 747 swings and the brake unit 744 drives the two lining plates toward the disk 72 and stop the disk 72. A resilient member is connected between the two lining plates to provide a force to return the two lining plates.

The first part 741 includes a connection portion 751 so as to be connected to one of the lugs 73 to form a “connection A”. The first and second parts 741, 742 include two connection portions 761, 762 which are “connection B” so that the two parts 741, 742 are connected to each other. The other lug 73 is connected to another connection portion 752 on the first part 741 and forms a “connection C”. Each connection of the “connection A”, “connection B” and “connection C” includes its individual tolerance, each threaded hole of the connection includes another tolerance so that the accumulated tolerance causes the brake disk 72 located at a position that the lining plates cannot evenly and simultaneously touch the disk 72. This makes the lining plates to be worn out quickly and the braking force is not evenly applied to the brake disk 72.

FIG. 11 shows another embodiment of the conventional brake assembly 74 which includes the first and second parts 741, 742 and a connection member 77 which is used to connect the two parts 741, 742 on the lugs 73. The more number of the parts needed for the brake assembly, the more accumulated tolerance can be.

### SUMMARY OF THE INVENTION

The present invention relates to an integral combination of a front fork and a brake assembly. The front fork is connected to a wheel shaft and the brake assembly is integrally connected to the front fork so that assembly steps are simplified. A chamber is defined in the brake assembly so as to receive a brake mechanism therein and the brake mechanism includes two lining plates and a brake unit. A groove is defined between the two lining plates and a brake disk is located between the two lining plates which are moved toward each other by the brake unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view of the combination of the present invention;

FIG. 2 is an exploded view to show the combination of the present invention;

FIG. 3 is a cross sectional view of the combination of the present invention;

FIG. 4 is a perspective view to show the combination of the present, invention;

FIG. 5 is a cross sectional view of another embodiment of the combination of the present invention;

FIG. 6 shows yet another embodiment of the combination of the present invention;

FIG. 7 is a side view to show that the combination of the present invention is driven by hydraulic power;

FIG. 8 is a cross sectional view of the combination of the present invention;

FIG. 9 is a side view of a conventional brake assembly connected to a front fork;

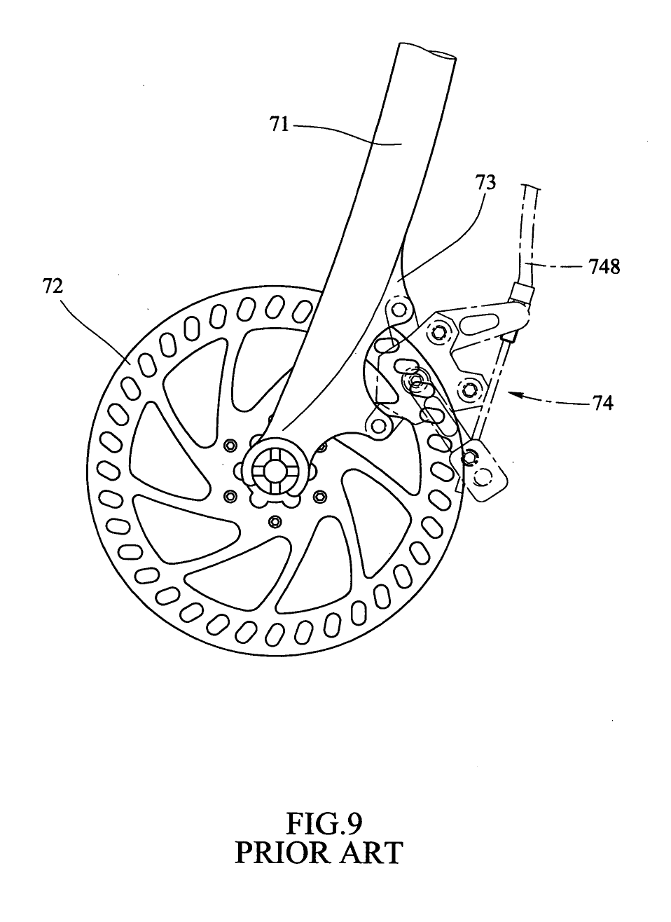

FIG. 10 is an exploded view of the conventional brake assembly and the front fork, and

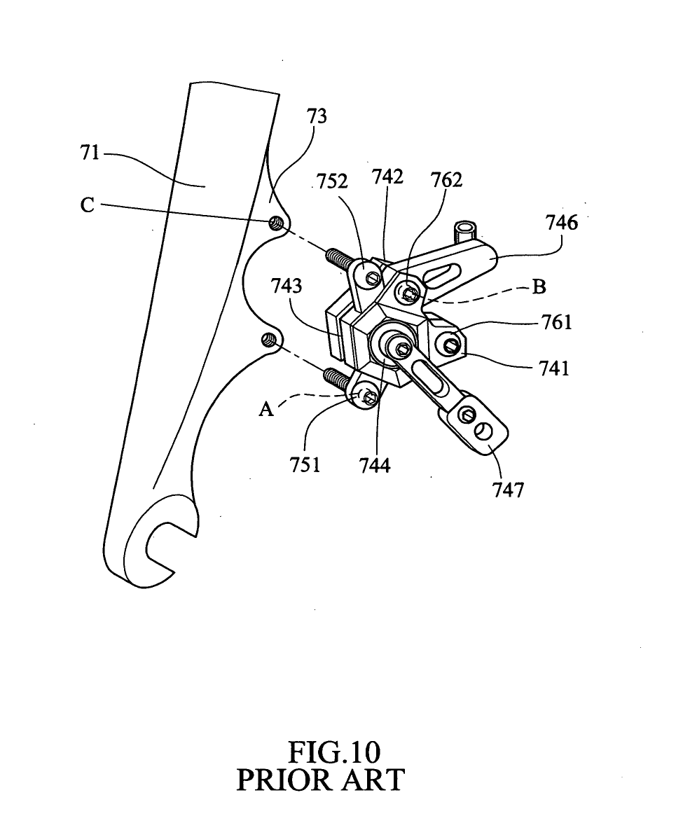

FIG. 11 shows another type of the conventional brake assembly and the front fork.

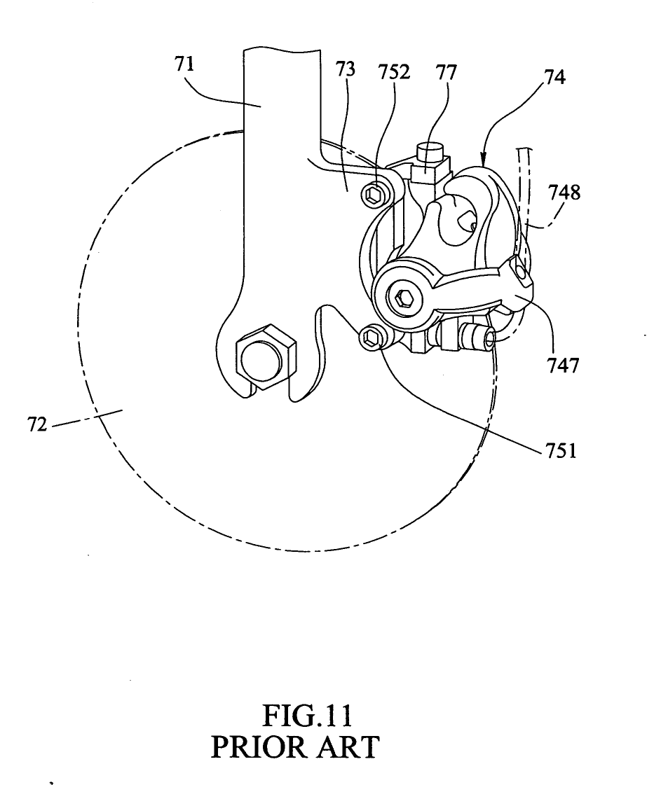

### DETAILED DESCRIPTION OF THE PREFERRED EMBODIMENT

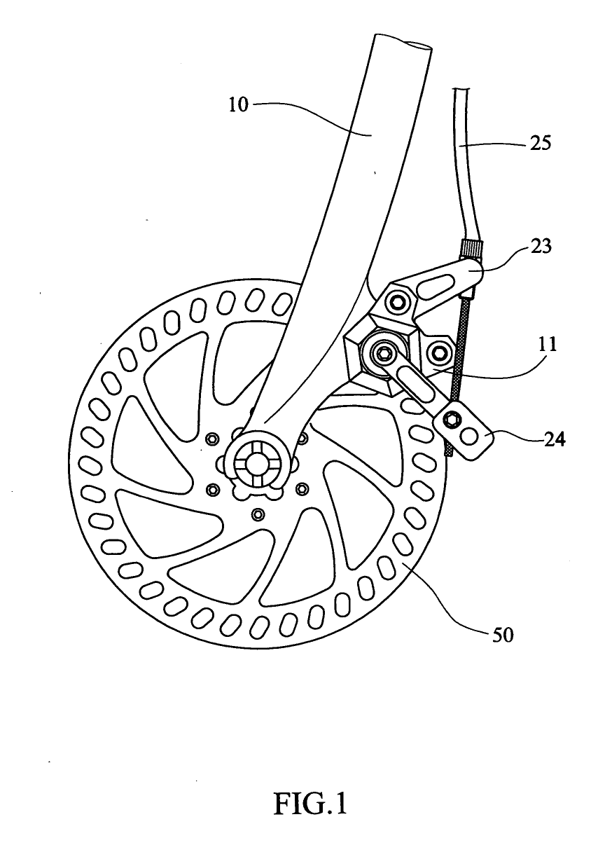

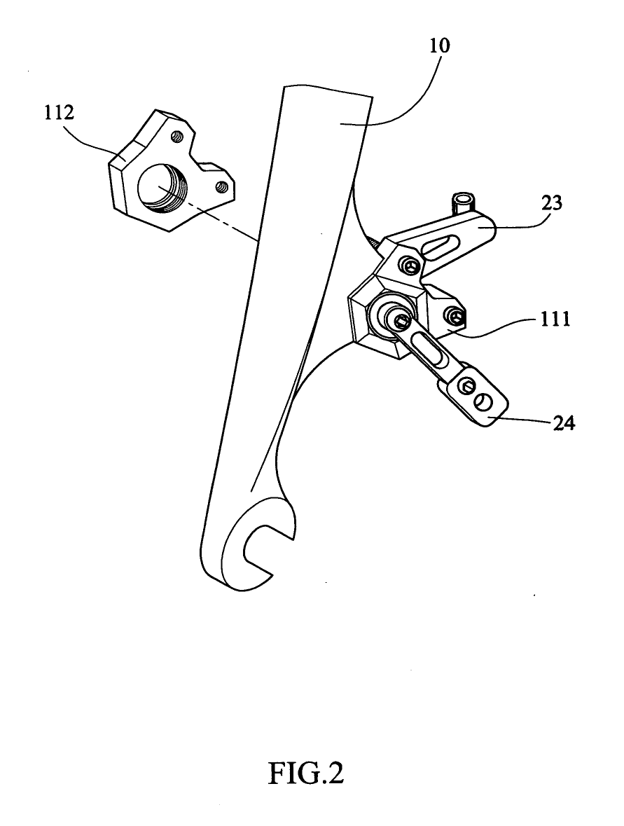

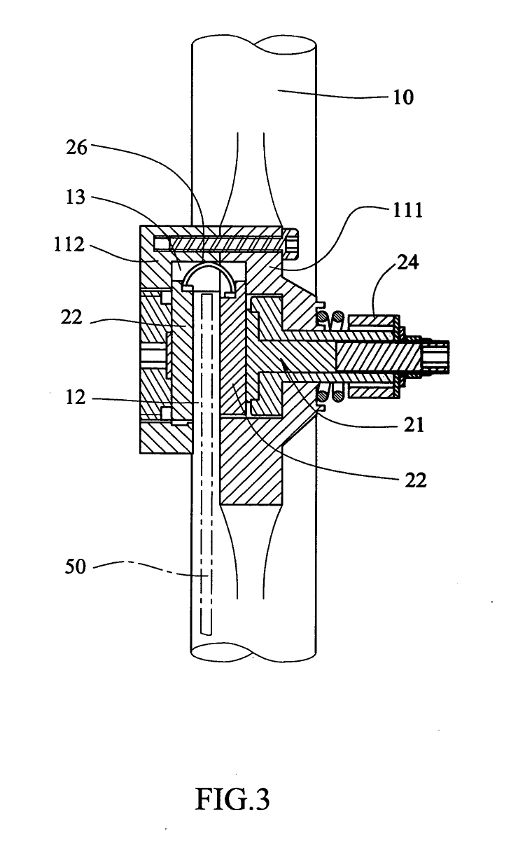

FIGS. 1 to 3 show the integral combination of a front fork 10 and a brake assembly 11 of the present invention. The front fork 10 is connected to a wheel shaft and the brake assembly 11 is integrally connected to the front fork 10. The brake assembly 11 includes a plurality of parts which includes a first part 111 and a second part 112. The first part 111 is integrally connected to the front fork 10 and the second part 112 is connected to the first part 111. A chamber 13 is defined in the brake assembly 11 and a brake mechanism 20 is received in the chamber 13. The brake mechanism 20 includes two lining plates 22 and a brake unit 21. A groove 12 is defined between the two lining plates 22 and a brake disk 50 is located between the two lining plates 22 which are moved toward each other by the brake unit 21. A resilient member 26 such as a spring, is connected between the two lining plates 22.

The brake mechanism 20 includes a fixed arm 23 integrally connected to the brake assembly 11 and a swing arm 24 which is pivotably connected to a central portion of the brake assembly 11 and is connected to the brake unit 21. A brake cable 25 extends through the fixed arm 23 and is connected to a distal end of the swing arm 24. When the user pulls the brake cable 26 which pivots the swing arm 24 so as to drive the two lining plates 22 to clamp the brake disk 50 and stop the wheel.

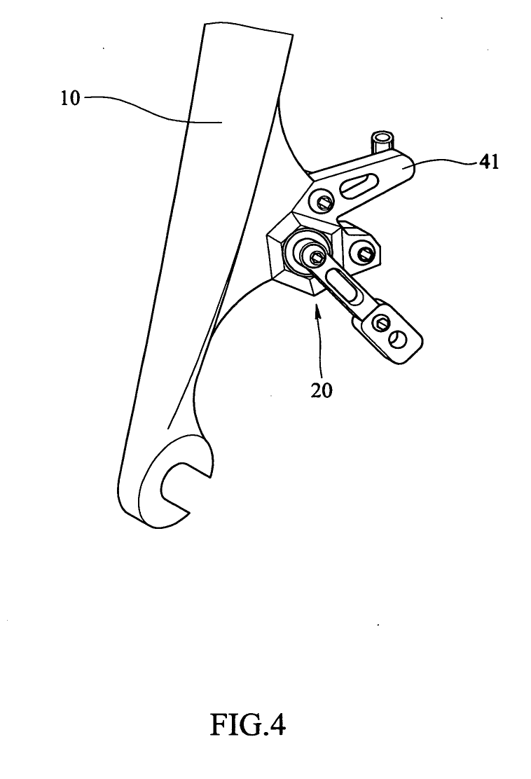

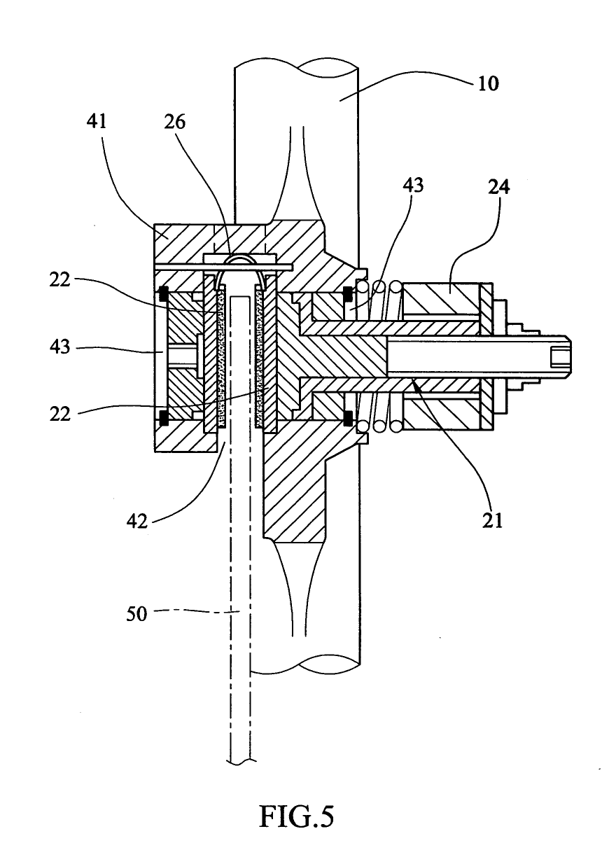

FIGS. 4 and 5 show another embodiment wherein a brake assembly 41 is integrally connected to the front fork 40 and two parts as mentioned in the previous embodiment are integrally made as one piece. A chamber 43 and a groove 42 are defined in the brake assembly 41. The brake mechanism 20 is received in the chamber 43 of the brake assembly 41. By this way, the number of the parts of the brake assembly 41 is reduced.

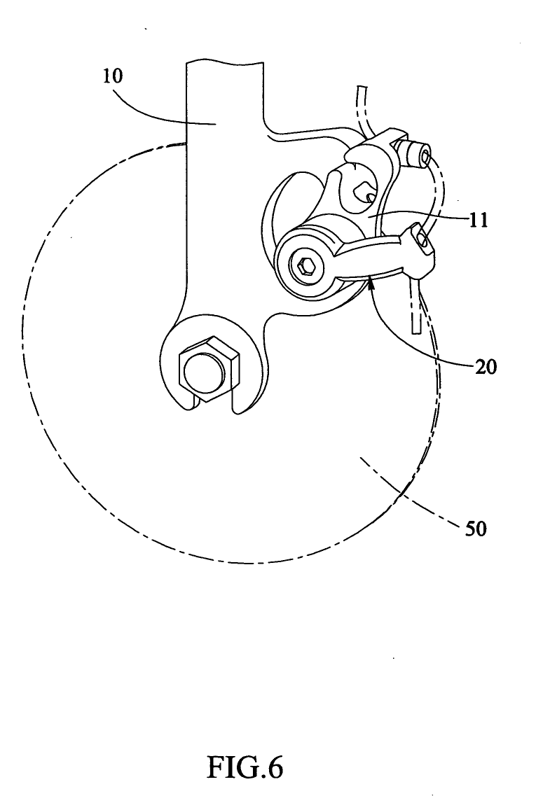

FIG. 6 shows yet another embodiment wherein the structure of the brake assembly is more complicated. The brake assembly 20 can be cooperated with the integral front fork 10 and the brake assembly, or the integral front fork 10 and the first part 111 with the individual second part 112.

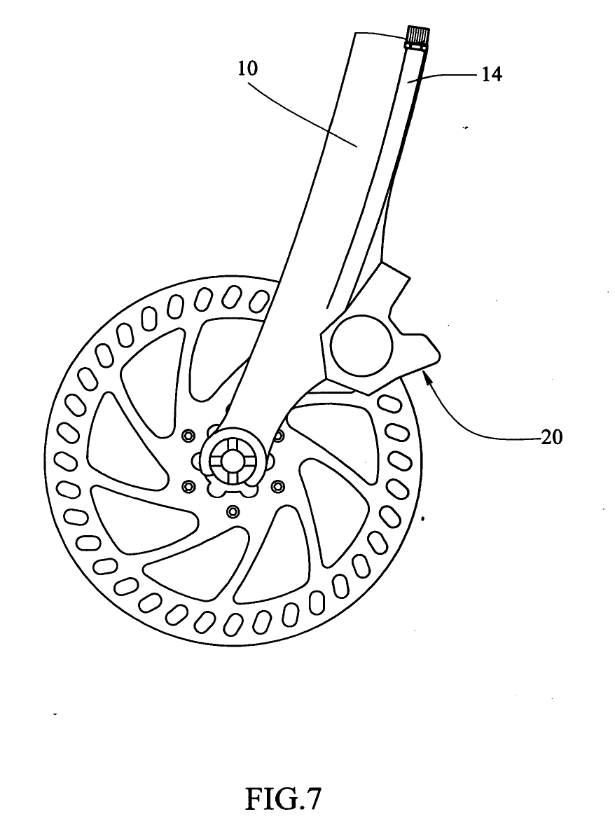

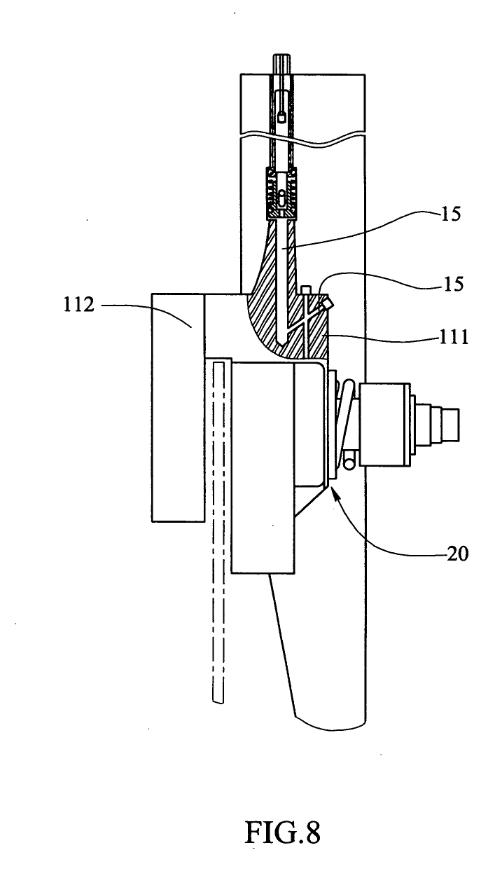

FIGS. 7 and 8 show that hydraulic power is employed and the front fork 10 includes a hose 14 and the brake assembly 11 includes a path 15 which communicates with the hose 14. The brake assembly 11 includes a first part 111 and a second part 112, the path 15 is defined in the first part 111 which is integrally connected to the front fork 10 and the second part 112 is connected to the first part 111, the groove 12 is defined between the first and second parts 111, 112.

The integral front fork 10 and the mechanism assembly 11 simplifies the manufacturing steps and lowers the cost. The integral structure reduces the accumulated tolerance so as to improve the wearing of the lining plates 22 and the brake disk 50. The less accumulated tolerance is benefit to adjust the gaps between the brake disk 50 and the lining plates 22. The less number of the parts can reduce the total weight of the brake assembly. The present invention can be cooperated with mechanical brake assembly, hydraulic brake assembly and semi-hydraulic brake assembly.

While we have shown and described the embodiment in accordance with the present invention, it should be clear to those skilled in the art that further embodiments may be made without departing from the scope of the present invention.

What is claimed is:

1. An integral combination of a front fork and a brake assembly, wherein the front fork is connected to a wheel shaft and the brake assembly is integrally connected to the front fork, a chamber is defined in the brake assembly and a brake mechanism is received in the chamber, the brake mechanism includes two lining plates and a brake unit, a groove is defined between the two lining plates and a brake disk is located between the two lining plates which are moved toward each other by the brake unit.

2. The combination as claimed in claim 1, wherein the brake assembly includes a plurality of parts which includes a first part and a second part, the first part is integrally connected to the front fork and the second part is connected to the first part, the groove is defined between the first and second parts.

3. The combination as claimed in claim 1, wherein the brake mechanism includes a fixed arm integrally connected to the brake assembly and a swing arm which is pivotably connected to a central portion of the brake assembly and is connected to the brake unit, a brake cable extending through the fixed arm and is connected to a distal end of the swing arm.

4. The combination as claimed in claim 1, wherein the brake mechanism includes a resilient member connected between the two lining plates.

5. The combination as claimed in claim 4, wherein the resilient member is a spring.

6. The combination as claimed in claim 1, wherein the front fork includes a hose and the brake assembly includes a path which communicates with the hose.

7. The combination as claimed in claim 6, wherein the brake assembly includes a first part and a second part, the path is defined in the first part which is integrally connected to the front fork and the second part is connected to the first part, the groove is defined between the first and second parts.
